(19) United States
(12) Patent Application Publication
(10) Pub. No.: US 2025/0357992 A1
(43) Pub. Date: Nov. 20, 2025

(54) METHOD OF CONTROL APPARATUS, METHOD OF RADIO TERMINAL, AND CONTROL APPARATUS

(71) Applicant: NEC Corporation, Tokyo (JP)

(72) Inventors: Daichi SHIRASE, Tokyo (JP); Kazushi MURAOKA, Tokyo (JP); Toshiki Takeuchi, Tokyo (JP); Takanobu DOI, Tokyo (JP); Naoto ISHII, Tokyo (JP)

(73) Assignee: NEC Corporation, Tokyo (JP)

(21) Appl. No.: 19/186,839

(22) Filed: Apr. 23, 2025

(30) Foreign Application Priority Data
May 14, 2024 (JP) 2024-078905

(51) Int. Cl. H04B 7/06; H04W 28/02; H04W 72/044; H04W 72/51

(52) U.S. Cl. CPC H04B 7/06952; H04W 28/0226; H04W 72/046; H04W 72/51

(57) ABSTRACT

A control apparatus according to the present disclosure is a control apparatus that controls at least one base station, and includes: an area setting unit configured to divide at least one communication area of the at least one base station into a plurality of sub-areas, based on an index indicating a radio channel characteristic or a coverage area of each of a plurality of beams of the at least one base station; and a determination unit configured to determine communication operation to be applied to a target terminal, based on information related to a sub-area associated to the target terminal.

### INCORPORATION BY REFERENCE

This application is based upon and claims the benefit of priority from Japanese patent application No. 2024-078905, filed on May 14, 2024, the disclosure of which is incorporated herein in its entirety by reference.

### TECHNICAL FIELD

The present disclosure relates to a control apparatus, a radio terminal, a method, and a program.

### BACKGROUND ART

A technique for allocating a radio resource in a cell, based on statistical information relating to a channel state according to a position in the cell has been proposed (e.g., Patent Literature 1). In the technique disclosed in Patent Literature 1, a cell is divided into a plurality of regions, and channel-related information is accumulated in units of regions. Then, based on the channel-related information accumulated in units of regions, region statistical information relating to a channel state for each region is generated. Then, a base station specifies a region in which a radio terminal is located, and allocates a radio resource, based on the region statistical information associated to the region.
[Patent Literature 1] Japanese Unexamined Patent Application Publication No. 2015-15521

### SUMMARY

Meanwhile, there is a possibility that there is a variation in a channel state of each of a plurality of points in a region. However, since the region is fixed in the technique disclosed in Patent Literature 1, there is a possibility that region statistical information does not accurately represent the channel state of the entire region. As a result, there is a possibility that, in the technique disclosed in Patent Literature 1, radio operation to be applied to a radio terminal is not possible to be determined accurately.

An example object of the present disclosure is to provide a control apparatus, a radio terminal, a method, and a program that are capable of accurately determining radio operation to be applied to a radio terminal. Note that, this object is merely one of a plurality of the objects to be achieved by a plurality of example embodiments disclosed in the present specification. Another object or a problem and a novel feature will be apparent from the description of the present specification or the accompanying drawings.

In a first example aspect, a control apparatus according to the present disclosure is a control apparatus that controls at least one base station, and includes: an area setting unit configured to divide at least one communication area of the at least one base station into a plurality of sub-areas, based on at least one of an index indicating a radio channel characteristic and a coverage area of each of a plurality of beams of the at least one base station; and a determination unit configured to determine communication operation to be applied to a target terminal, based on information related to a sub-area associated to the target terminal.

In a second example aspect, a first radio terminal according to the present disclosure is a first radio terminal that communicates with at least one base station, and includes: an area setting unit configured to divide a movement path of the first radio terminal into a plurality of sub-areas, based on at least one of an index indicating a radio channel characteristic and a coverage area of each of a plurality of beams of the at least one base station; and a determination unit configured to determine communication operation to be applied to the first radio terminal, based on information related to a sub-area associated to the first radio terminal.

In a third example aspect, a method according to the present disclosure is a method executed by a control apparatus that controls at least one base station, and includes: dividing at least one communication area of the at least one base station into a plurality of sub-areas, based on at least one of an index indicating a radio channel characteristic and a coverage area of each of a plurality of beams of the at least one base station; and determining communication operation to be applied to a target terminal, based on information related to a sub-area associated to the target terminal.

In a fourth example aspect, a program according to the present disclosure causes a control apparatus that controls at least one base station to execute processing including: dividing at least one communication area of the at least one base station into a plurality of sub-areas, based on at least one of an index indicating a radio channel characteristic and a coverage area of each of a plurality of beams of the at least one base station; and determining communication operation to be applied to a target terminal, based on information related to a sub-area associated to the target terminal.

An example advantage according to the present disclosure is possible to provide a control apparatus, a radio terminal, a method, and a program that are capable of accurately determining radio operation to be applied to a radio terminal.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a diagram illustrating one example of a radio communication system according to the present disclosure;

FIG. 2 is a block diagram illustrating one example of a control apparatus according to the present disclosure;

FIG. 3 is a flowchart illustrating one example of processing operation of the control apparatus according to the present disclosure;

FIG. 4 is a block diagram illustrating one example of a base station according to the present disclosure;

FIG. 5 is a block diagram illustrating another example of the control apparatus according to the present disclosure;

FIG. 6 is a block diagram illustrating one example of a control unit according to the present disclosure;

FIG. 7 is a conceptual diagram of a channel measurement database according to the present disclosure;

FIG. 8 is a diagram for describing one example of an index indicating a radio channel characteristic according to the present disclosure;

FIG. 9 is a diagram for describing one example of a method of dividing a communication area into a plurality of sub-areas according to the present disclosure;

FIG. 10 is a diagram for describing one example of a method of determining communication operation to be applied to a target terminal according to the present disclosure;

FIG. 11 is a block diagram illustrating one example of a radio apparatus according to the present disclosure;

FIG. 12 is a flowchart illustrating another example of the processing operation of the control apparatus according to the present disclosure;

FIG. 13 is a diagram for describing a Doppler shift value according to the present disclosure;

FIG. 14 is a diagram for describing another example of the method of dividing a communication area into a plurality of sub-areas according to the present disclosure;

FIG. 15 is a diagram for describing another example of the method for dividing a communication area into a plurality of sub-areas according to the present disclosure;

FIG. 16 is a block diagram illustrating one example of a radio terminal according to the present disclosure;

FIG. 17 is a block diagram illustrating another example of the control apparatus according to the present disclosure;

FIG. 18 is a block diagram illustrating another example of the base station and the radio terminal according to the present disclosure;

FIG. 19 is a block diagram illustrating another example of the base station and the radio terminal according to the present disclosure;

FIG. 20 is a block diagram illustrating another example of the base station and the radio terminal according to the present disclosure;

FIG. 21 is a diagram illustrating a configuration example of the control apparatus; and

FIG. 22 is a diagram illustrating a configuration example of the radio terminal.

### EXAMPLE EMBODIMENT

Hereinafter, example embodiments will be described with reference to the drawings. Note that, in the present disclosure, the drawings may be associated with one or more example embodiments. In addition, each element of the drawings may apply to one or more example embodiments. In addition, in the example embodiments, the same or equivalent elements are denoted by the same reference signs, and redundant description thereof will be omitted.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

### First Example Embodiment

### [Overview of Radio Communication System]

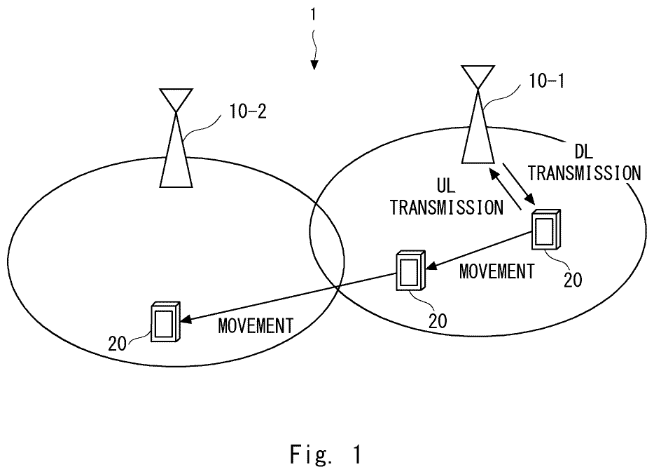

FIG. 1 is a diagram illustrating one example of a radio communication system according to the present disclosure. In FIG. 1, a radio communication system 1 includes base stations 10-1 and 10-2, and a radio terminal 20. The radio communication system 1 may be, for example, a system compliant with a technical specification of a third generation partnership project (3GPP (registered trademark)). Note that, in the following description, in a case where it is not necessary to distinguish the base stations 10-1 and 10-2, each of the base stations 10-1 and 10-2, or the base stations 10-1 and 10-2 collectively may be referred to simply as a base station 10. In addition, FIG. 1 illustrates two base stations 10 and one radio terminal 20, but the number of base stations 10 and the number of radio terminals 20 are not limited thereto.

The base station 10 provides one or more cells. The base station 10 communicates with the radio terminal 20 existing in the cell. The base station 10 may be, for example, a base station or a base station element of a radio access network (RAN). As illustrated in FIG. 1, the base station 10 transmits a control signal or data to the radio terminal 20 via a downlink (DL). In addition, the base station 10 receives a control signal or data from the radio terminal 20 via an uplink (UL). Both of the base station 10 and the radio terminal 20 can perform transmit and receive a signal by performing beamforming.

The radio terminal 20 may be, for example, a mobile terminal such as a smartphone, a mobile phone, or a tablet, or a sensing device. In addition, the radio terminal 20 may be a relay apparatus having a relay function. As illustrated in FIG. 1, the radio terminal 20 receives a control signal or data from the base station 10 via the DL. In addition, the radio terminal 20 transmits a control signal or data to the base station 10 via the UL. As a result, the radio terminal 20 uses various radio communication services provided by the radio communication system. The radio terminal 20 may be, for example, a relay base station mounted on a railway or a vehicle.

### [Configuration Example of Control Apparatus]

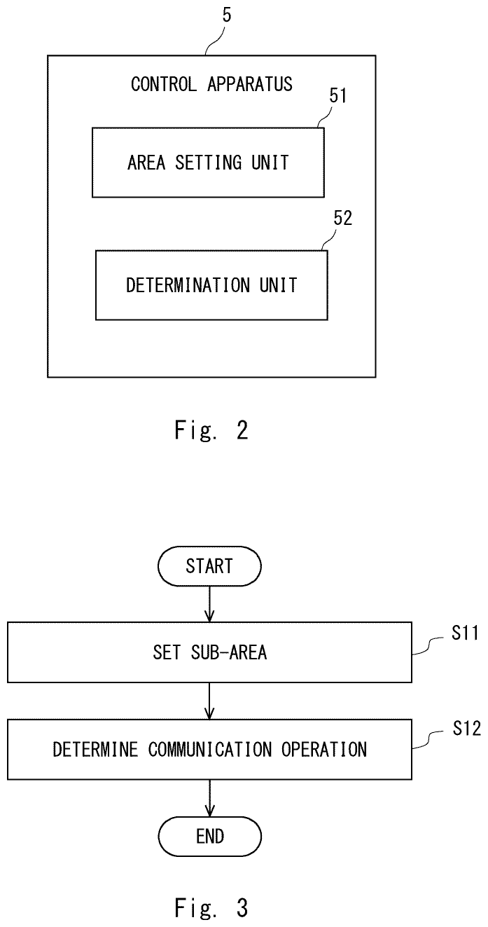

FIG. 2 is a block diagram illustrating one example of a control apparatus according to the present disclosure. In FIG. 2, a control apparatus 5 includes an area setting unit 51, and a determination unit 52. The control apparatus 5 is included in the base station 10 or the radio terminal 20.

(in a Case where the Control Apparatus is Included in the Base Station)

The area setting unit 51 divides at least one communication area of the base station 10 into a plurality of sub-areas, based on at least one of an index indicating a radio channel characteristic and a coverage area of each of a plurality of beams of the base station 10. For example, the area setting unit 51 may repeatedly perform processing of dividing the communication area into the plurality of sub-areas at an interval of a predetermined time length or more. The at least one communication area of the base station 10 may be, for example, a cell of the base station 10, or a sector thereof. Note that, in a case where both of the index indicating the radio channel characteristics and the coverage area of each of the plurality of beams of the base station 10 are used, the at least one communication area of the base station 10 may be divided into the plurality of sub-areas as follows. For example, the area setting unit 51 divides the at least one communication area of the base station 10 into a plurality of divided areas, based on the index indicating the radio channel characteristic. Then, the area setting unit 51 divides each divided area into the plurality of sub-areas, based on the coverage area of each of the plurality of beams of the base station 10.

The determination unit 52 determines communication operation to be applied to a target terminal, based on information related to a sub-area associated to the target terminal. The target terminal is the radio terminal 20 being a target for which the communication operation is determined. The “information related to a sub-area associated to the target terminal” may be, for example, type information of a sub-area in which the target terminal is located, an index indicating the radio channel characteristic in a sub-area in which the target terminal is located, or information indicating a beam to which the target terminal is connected. In addition, the “index indicating the radio channel characteristic” may be, for example, reception power of a signal propagated through a radio channel, a channel gain of the radio channel, a path gain, a path loss, a signal to noise power ratio (SNR), or a signal to interference and noise power ratio (SINR). At this time, the “communication operation to be applied to the target terminal” may be, for example, transmission power control, radio resource allocation, or connected cell/beam selection. In addition, the “index indicating the radio channel characteristic” may be, for example, an index related to a deviation of a radio frequency, an index related to a speed of time variation of a channel parameter, or an index related to a propagation delay of a radio wave. At this time, the “communication operation to be applied to the target terminal” may be, for example, processing of correcting the deviation of the radio frequency, processing of setting a measurement period of the channel parameter, or processing of compensating for the propagation delay.

(in a Case where the Control Apparatus is Included in the Radio Terminal)

The area setting unit 51 divides a movement path of the radio terminal 20 into a plurality of sub-areas, based on at least one of an index indicating a radio channel characteristic and a coverage area of each of a plurality of beams of the base station 10.

The determination unit 52 determines communication operation to be applied to the radio terminal 20, based on information related to a sub-area associated to the radio terminal 20. The “information related to a sub-area associated to the radio terminal 20” may be, for example, type information of a sub-area in which the radio terminal 20 is located, an index indicating the radio channel characteristic in a sub-area in which the radio terminal 20 is located, or information indicating a beam to which the radio terminal 20 is connected. In addition, the “index indicating the radio channel characteristic” may be, for example, reception power of a signal propagated through a radio channel, a channel gain of the radio channel, a path gain, a path loss, a signal to noise power ratio (SNR), or a signal to interference and noise power ratio (SINR). At this time, the “communication operation to be applied to the radio terminal 20” may be, for example, transmission power control, radio resource allocation, or connected cell/beam selection. In addition, the “index indicating the radio channel characteristic” may be, for example, an index related to a deviation of a radio frequency, an index related to a speed of time variation of a channel parameter, or an index related to a propagation delay of a radio wave. At this time, the “communication operation to be applied to the radio terminal 20” may be, for example, processing of correcting the deviation of the radio frequency, processing of setting a measurement period of the channel parameter, or processing of compensating for the propagation delay.

### [Operation Example of Control Apparatus]

FIG. 3 is a flowchart illustrating one example of processing operation of the control apparatus according to the present disclosure. A processing flow illustrated in FIG. 3 may be repeatedly executed at an interval of a predetermined time length or more.

(in a Case where the Control Apparatus is Included in the Base Station)

The area setting unit 51 divides at least one communication area of the base station 10 into a plurality of sub-areas, based on at least one of an index indicating a radio channel characteristic and a coverage area of each of a plurality of beams of the base station 10 (step S11).

The determination unit 52 determines communication operation to be applied to a target terminal, based on information related to a sub-area associated to the target terminal (step S12).

(in a Case where the Control Apparatus is Included in the Radio Terminal)

The area setting unit 51 divides a movement path of the radio terminal 20 into a plurality of sub-areas, based on at least one of an index indicating a radio channel characteristic and a coverage area of each of a plurality of beams of the base station 10 (step S11).

The determination unit 52 determines communication operation to be applied to the radio terminal 20, based on information related to a sub-area associated to the radio terminal 20 (step S12).

As described above, according to a first example embodiment, in the control apparatus 5, the area setting unit 51 divides at least one communication area of the base station 10 into a plurality of sub-areas, based on at least one of an index indicating a radio channel characteristic and a coverage area of each of a plurality of beams of the base station 10. The determination unit 52 determines communication operation to be applied to a target terminal, based on information related to a sub-area associated to the target terminal.

With a configuration of the control apparatus 5, it is possible to accurately determine radio operation to be applied to the target terminal. In other words, an index indicating the radio channel characteristic changes over time. In addition, since the plurality of beams of the base station 10 are also adjusted by the base station 10, the coverage area of each of the plurality of beams of the base station 10 also changes over time. Then, since the control apparatus 5 can adjust the sub-area, based on a parameter that changes over time, it is possible to set the sub-area that matches a situation at each timing. Then since the control apparatus 5 determines the communication operation to be applied to the target terminal, based on information related to the sub-area associated to the target terminal, it is possible to accurately determine the radio operation to be applied to the target terminal.

### Second Example Embodiment

Second to seventh example embodiments correspond to a case where a control apparatus described above is included in a base station. Since a basic configuration of a radio communication system according to the second example embodiment is the same as that of the radio communication system 1, reference is made to FIG. 1.

### [Configuration Example of Base Station]

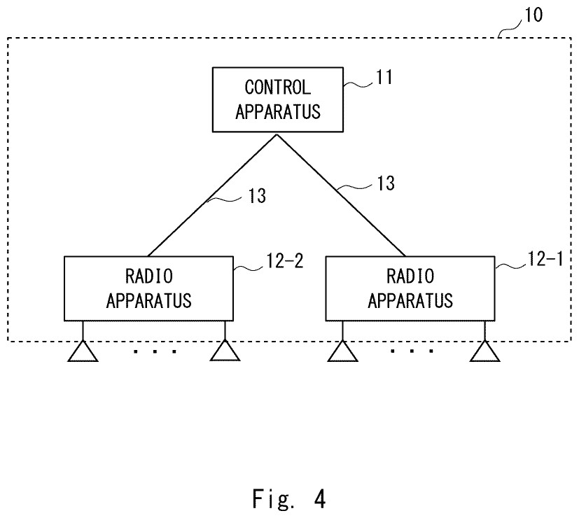

FIG. 4 is a block diagram illustrating one example of a base station according to the present disclosure. In FIG. 4, a base station 10 includes a control apparatus 11, and radio apparatuses 12-1 and 12-2. In the following description, in a case where it is not necessary to distinguish the radio apparatuses 12-1 and 12-2, each of the radio apparatuses 12-1 and 12-2, or the radio apparatuses 12-1 and 12-2 collectively may be referred to simply as a radio apparatus 12. In FIG. 4, the base station 10 includes two radio apparatuses 12, but the number of radio apparatuses 12 is not limited thereto. In other words, the base station 10 may include one radio apparatus 12, or may include three or more radio apparatuses 12. Note that, the control apparatus 11 corresponds to the above-described control apparatus 5.

The control apparatus 11 may be, for example, a central unit (CU), a distributed unit (DU), a baseband unit (BBU), or an RAN intelligent controller (RIC). In addition, the control apparatus 11 may be a configuration providing some functions of a radio unit (RU).

In addition, in the example in FIG. 4, the control apparatus 11 and the radio apparatus 12 are arranged in the same base station, but the control apparatus 11 and the radio apparatus 12 may be arranged at physically separate positions. In addition, a plurality of the radio apparatuses 12 may be arranged geographically in a distributed manner.

The control apparatus 11 is connected to the radio apparatus 12 via a transmission path 13. The control apparatus 11 is configured in such a way as to communicate with one or a plurality of radio terminals 20 via the radio apparatus 12.

The transmission path 13 may be an optical fiber, a metal cable, or a radio propagation path. For example, a radio over fiber (RoF) technique may be applied between the control apparatus 11 and the radio apparatus 12. In another example, a common public radio interface (CPRI) technique, an evolved CPRI (eCPRI) technique, or the like may be applied between the control apparatus 11 and the radio apparatus 12.

### [Configuration Example of Control Apparatus]

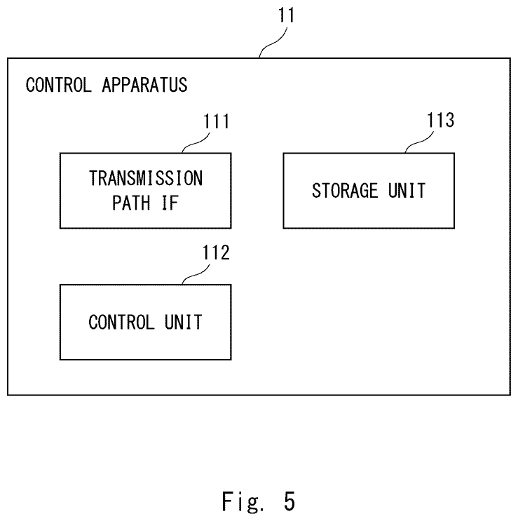

FIG. 5 is a block diagram illustrating another example of the control apparatus according to the present disclosure. In FIG. 5, the control apparatus 11 includes a transmission path interface 111, a control unit 112, and a storage unit 113.

The transmission path IF 111 is an interface for communicating with the radio apparatus 12 via the transmission path 13.

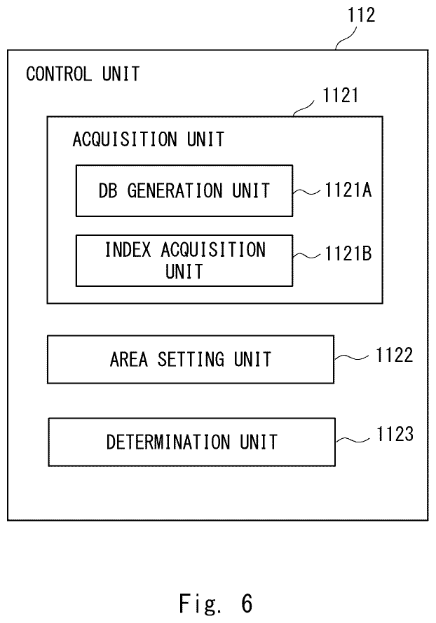

FIG. 6 is a block diagram illustrating one example of a control unit according to the present disclosure. In FIG. 6, the control unit 112 includes an acquisition unit 1121, an area setting unit 1122, and a determination unit 1123.

The acquisition unit 1121 acquires an “index indicating a radio channel characteristic” described above.

For example, the acquisition unit 1121 includes a database (DB) generation unit 1121A, and an index acquisition unit 1121B.

The DB generation unit 1121A acquires channel measurement data (e.g., information relating to a position of the radio terminal 20, and a value of a channel parameter at the position) between the base station 10 and the radio terminal 20. However, the channel measurement data to be acquired may be channel measurement data of a radio terminal (the radio terminal 20 or another radio terminal) that has performed communication with the base station 10 in a past, or may be channel data acquired by simulation. The channel data of the radio terminal may be measured based on a UL reference signal (RS) transmitted by the radio terminal. The UL reference signal may be, for example, one or both of SRS and DMRS. The radio terminal may measure a channel, based on a DL RS transmitted by the base station 10, and report the measurement result to the base station 10 as channel data of the radio terminal. The DL RS may be, for example, an SS/PBCH block (SSB), a channel state information reference signal (CSI-RS), a demodulation reference signal (DMRS), or a phase tracking reference signal (PT-RS). Note that, a specific example of the channel parameter will be described later.

The DB generation unit 1121A registers the acquired channel measurement data in a database. For example, the DB generation unit 1121A may register the acquired channel measurement data in the database for each radio terminal type. For example, the channel measurement data may be labeled for each radio terminal type, and stored in the storage unit 113. The “radio terminal type” may be determined based on, for example, a speed of a radio terminal, a movement path, a movement direction, a communication capability (including an antenna configuration, transmission power, a power class, and the like), a unique number or a unique name held by the radio terminal, and the like.

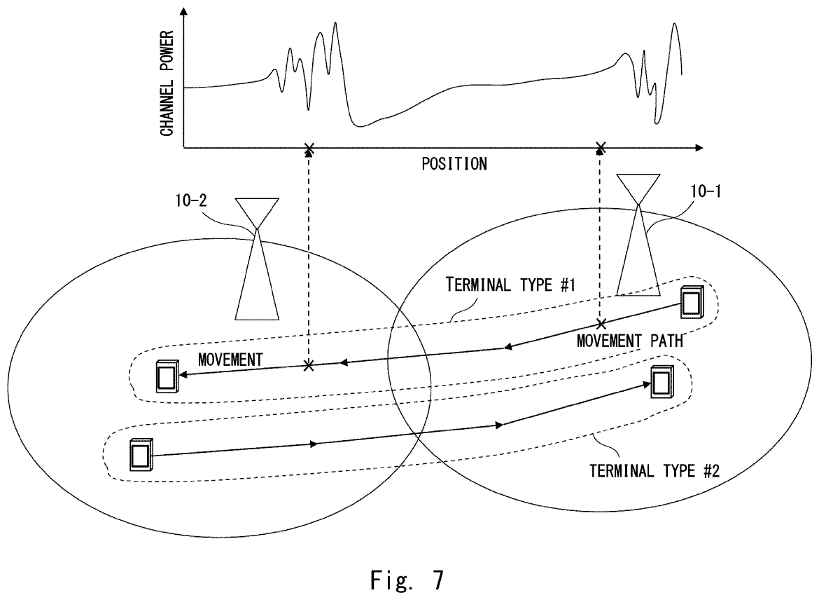

FIG. 7 is a conceptual diagram of a channel measurement database according to the present disclosure. However, in the example in FIG. 7, a terminal type #1 and a terminal type #2 having different movement paths and movement directions from each other are illustrated. The database of the terminal type #1 and the database of the terminal type #2 may each be configured by channel measurement data of a plurality of radio terminals determined to be the same terminal type. In a case of configuring by the channel measurement data of the plurality of radio terminals, the channel measurement data of one terminal type may be, for example, an average of channel measurement data of the plurality of radio terminals. In addition, FIG. 7 illustrates a graph representing channel power at each position along the movement path of the terminal type #1. However, in a case where a plurality of terminals are included in the database of the terminal type #1, a channel power value may be an average value of the channel power values of some or all of the plurality of terminals. In addition, in the example in FIG. 7, the channel measurement database for a position of the radio terminal is generated, but the position may be replaced with an index equivalent to the position as necessary. For example, a horizontal axis in FIG. 7 is not limited thereto, but may be a relative time based on a time point when the radio terminal enters a communication area of the base station 10, or may be an angle or the like of the radio terminal measured from an antenna position of the base station 10. In a case where the position of the radio terminal is used, for example, position information measured by a global positioning system (GPS) of the radio terminal may be used. In addition, in a case where the angle of the radio terminal measured from the antenna position of the base station 10 is used, an angle estimated by using various arrival angle estimation techniques or the like may be used.

The index acquisition unit 1121B calculates an index representing a radio channel characteristic for each position coordinate point in the communication area of the base station 10. However, the index acquisition unit 1121B does not necessarily have to calculate an index for a large number of coordinate points covering the entire communication area of the base station 10, and may calculate an index for a coordinate point partially covering the communication area. For example, in the example in FIG. 7, an index may be calculated for a coordinate point on a movement path of each terminal type or in a vicinity of the movement path thereof. In addition, the calculation of the index representing the radio channel characteristic may be performed for each radio terminal type. Hereinafter, the entire communication area covered by the base station may be referred to as a communication area of the base station. A part of the communication area of the base station being formed as an area on the movement path of a terminal type #n or in the vicinity of the movement path thereof may be referred to as a communication area of the terminal type #n. In addition, in a case where it is not necessary to particularly distinguish between the communication area of the base station and the communication area of the terminal type #n, both of them may be simply referred to as a communication area.

For example, the index acquisition unit 1121B calculates, as an “index indicating a radio channel characteristic”, an index indicating a speed of time variation of a channel parameter, based on the channel parameter among data registered in the database. The channel parameter may be reception power (i.e., channel power) of a signal propagated through a radio channel, a channel gain of the radio channel, a path gain, a path loss, a signal to noise power ratio, or a signal to interference and noise power ratio. Herein, as one example, a case where an index indicating a radio channel characteristic is an index representing a speed of time variation of channel power will be described.

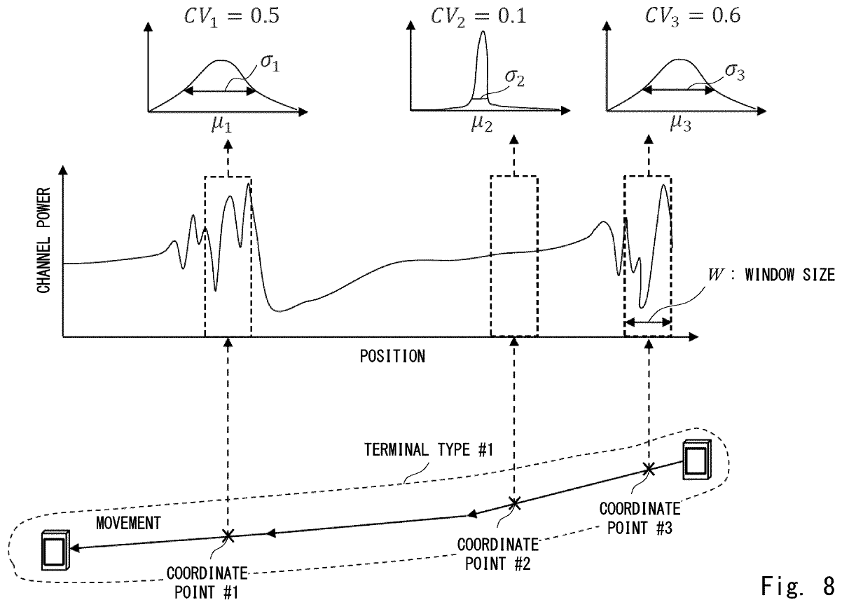

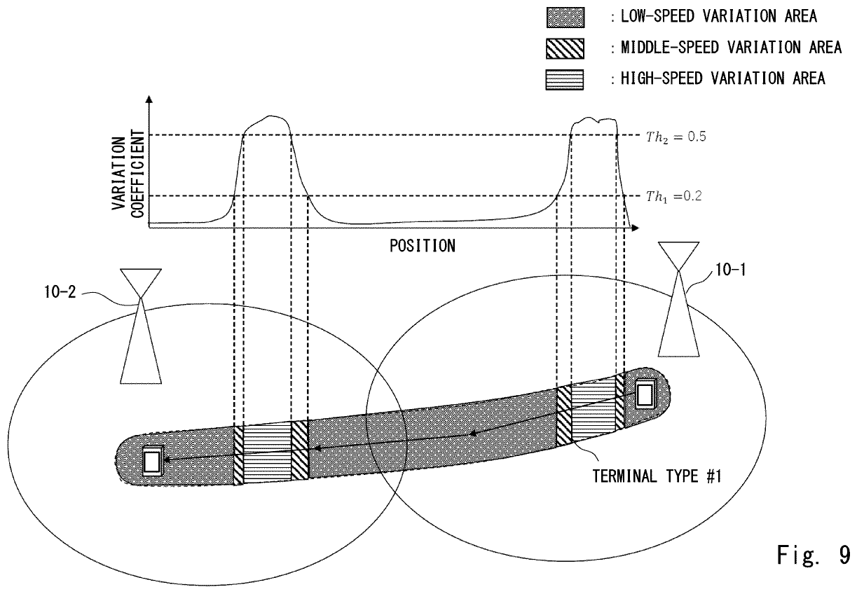

FIG. 8 is a diagram for describing one example of an index indicating the radio channel characteristic according to the present disclosure. In the example illustrated in FIG. 8, a variation coefficient represented by the following equation (1) is used as an index representing the speed of the time variation of the channel power.

$$[ Mathematical 1 ]$$

$$CV = σ / μ \qquad ( 1 )$$

FIG. 8 illustrates the variation coefficient of each of a coordinate point #1, a coordinate point #2, and a coordinate point #3. However, the variation coefficient is derived by calculating an average u and a standard deviation σ from distribution of channel power data within a range of a window size W centered on each coordinate point, and calculating the equation 1. In the example in FIG. 8, the variation coefficient becomes a large value at the coordinate point #1 and the coordinate point #3 where the time variation of the channel is intense, and the variation coefficient becomes small at the coordinate point #2 where the time variation of the channel is relatively gentle.

The area setting unit 1122 divides the communication area of the base station 10 into a plurality of sub-areas, based on an index indicating the radio channel characteristic.

FIG. 9 is a diagram for describing one example of a method of dividing a communication area into a plurality of sub-areas according to the present disclosure. In FIG. 9, the communication area of the terminal type #1 is a communication area to be divided. The area setting unit 1122 divides the communication area of the terminal type #1 into a plurality of sub-areas by using, for example, two threshold values Th1 and Th2, and an index indicating the speed of the time variation of the channel power at a plurality of points in the communication area of the terminal type #1. Specifically, the area setting unit 1122 allocates a point having the speed of the time variation of the channel power being equal to or greater than the threshold value Th1 to a “high-speed variation area”. In addition, the area setting unit 1122 allocates a point having the speed of the time variation of the channel power that is less than the threshold Th1 and is equal to or greater than the threshold Th2 to a “middle-speed variation area”. In addition, the area setting unit 1122 allocates a point having the speed of the time variation of the channel power being less than the threshold Th2 to a “low-speed variation area”.

The determination unit 1123 determines communication operation to be applied to a target terminal, based on information related to a sub-area associated to the target terminal. Herein, the information related to the sub-area associated to the target terminal may be type information of the sub-area in which the target terminal is located. In addition, the communication operation to be applied to the target terminal may be communication operation performed by the base station 10, may be communication operation performed by the target terminal, or may be both of them. In a case where the determination unit 1123 determines the communication operation performed by the target terminal, the base station 10 may notify the target terminal of the communication operation determined by the determination unit 1123. Then, the target terminal may determine operation related to communication of the target terminal, based on the notified information.

For example, in a case where the target terminal is located in the low-speed variation area, the determination unit 1123 may set a channel measurement period to 80 msec. In addition, in a case where the target terminal is located in the middle-speed variation area, the determination unit 1123 may set the channel measurement period to 40 msec. In addition, in a case where the target terminal is located in the high-speed variation area, the determination unit 1123 may set the channel measurement period to 20 msec. Note that, as a position of the target terminal, for example, position coordinates acquired from the GPS of the target terminal may be used.

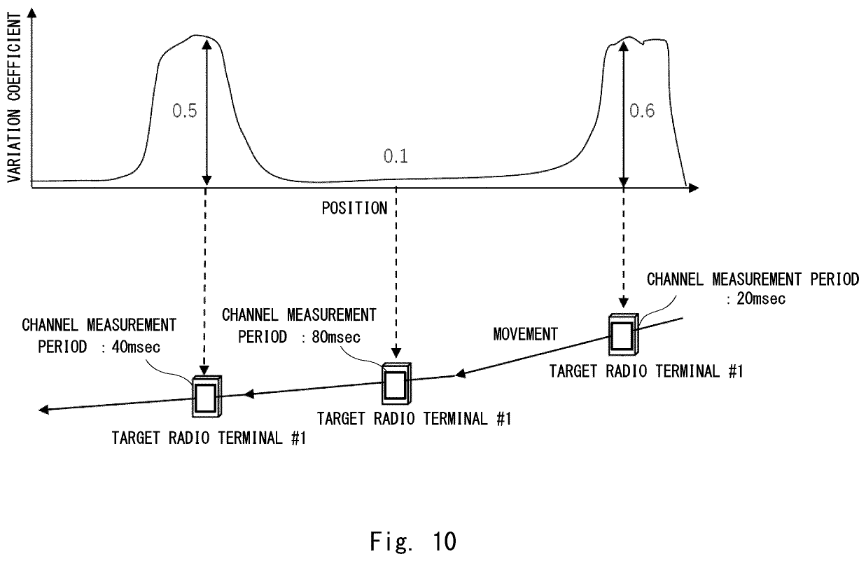

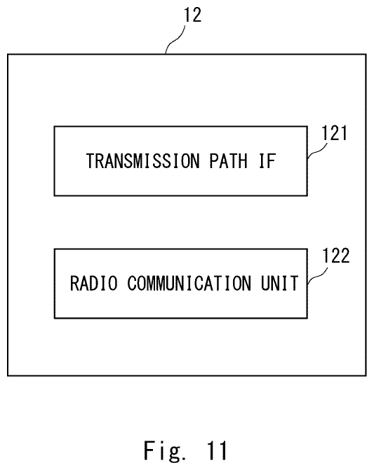

In other words, as illustrated in FIG. 10, in a case where the time variation of the channel is intense, the determination unit 1123 sets a period of the channel measurement to be short. As a result, it is possible to follow a channel state that fluctuates at high speed. On the other hand, in a case where the time variation of the channel is gentle, the determination unit 1123 sets the period of the channel measurement to be long. This makes it possible to suppress an unnecessary increase in power consumption and signaling. FIG. 10 is a diagram for describing one example of a method of determining communication operation to be applied to the target terminal according to the present disclosure.

### [Configuration Example of Radio Apparatus]

FIG. 11 is a block diagram illustrating one example of a radio apparatus according to the present disclosure. In FIG. 11, the radio apparatus 12 includes a transmission path IF 121, and a radio communication unit 122. The transmission path IF 121 is an interface for communicating with the control apparatus 11 via the transmission path 13.

The radio communication unit 122 is a component that performs radio communication with the radio terminal 20. For example, the radio communication unit 122 includes an antenna, a radio frequency (RF) circuit, and the like. The radio communication unit 122 transmits a radio frequency signal to the radio terminal 20 at a time of DL communication. In addition, the radio communication unit 122 receives a radio frequency signal from the radio terminal 20 at a time of UL communication. In addition, the radio communication unit 122 includes one or a plurality of antenna elements. In a case where the radio communication unit 122 includes the plurality of antenna elements, the radio communication unit 122 may have a full digital configuration in which each antenna element is connected to a respective RF circuit, or may have a sub-array configuration in which a sub-array configured by a plurality of antenna elements shares one RF circuit. In a case of the sub-array configuration, each sub-array may perform analog beamforming.

### [Operation Example of Control Apparatus]

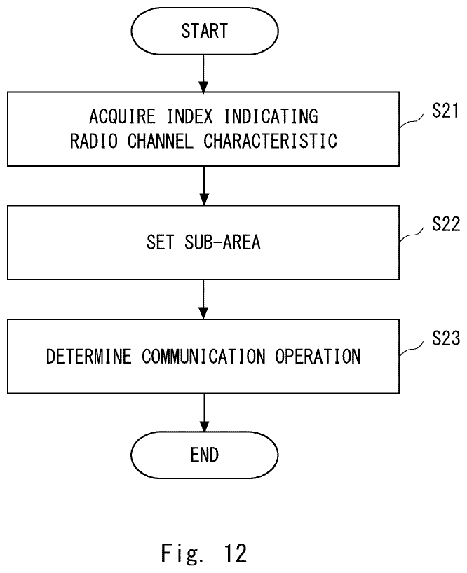

FIG. 12 is a flowchart illustrating another example of processing operation of the control apparatus according to the present disclosure. A processing flow illustrated in FIG. 12 may be repeatedly executed at an interval of a predetermined time length or more.

The acquisition unit 1121 acquires an index indicating a radio channel characteristic (step S21).

The area setting unit 1122 divides a communication area of the base station 10 into a plurality of sub-areas, based on an index indicating the radio channel characteristic (step S22).

The determination unit 1123 determines communication operation to be applied to a target terminal, based on information related to a sub-area associated to the target terminal (step S23).

### Third Example Embodiment

In a third example embodiment, an index related to a deviation of a radio frequency is used as an index indicating a radio channel characteristic. Note that, since a basic configuration of a radio communication system, a base station, and a radio terminal according to the third example embodiment is the same as that of the radio communication system 1, the base station 10, and the radio terminal 20, reference is made to FIGS. 1, 4 to 6, and 11.

In the third example embodiment, an acquisition unit 1121 acquires an index related to a deviation of a radio frequency as an “index indicating a radio channel characteristic”.

For example, in the third example embodiment, a DB generation unit 1121A acquires channel measurement data (e.g., information related to a position of the radio terminal 20, and a Doppler shift value at the position) between a base station 10 and a radio terminal 20. However, the channel measurement data to be acquired may be channel data of a radio terminal (the radio terminal 20 or another radio terminal) that has performed communication with the base station 10 in a past, or may be channel data acquired by simulation. Alternatively, the DB generation unit 1121A may acquire information related to the position of the radio terminal 20 and a velocity (speed and movement direction) at the position.

The DB generation unit 1121A registers the acquired channel measurement data in a database. For example, the DB generation unit 1121A may register the acquired channel measurement data in the database for each base station, for each cell, for each sector, or for each beam. In addition, the DB generation unit 1121A may register the acquired information related to the position of the radio terminal 20 and the acquired velocity (speed and movement direction) at the position in the database for each base station, for each cell, for each sector, or for each beam.

An index acquisition unit 1121B acquires an index indicating a radio channel characteristic for each position coordinate point in a communication area of the base station 10. For example, in a case where Doppler shift data between the radio terminal and the base station is held in the database, the index acquisition unit 1121B acquires a Doppler shift value for each position coordinate point in the communication area of the base station 10. In addition, in a case where the Doppler shift data between the radio terminal and the base station is not held in the database, the index acquisition unit 1121B acquires information related to the position and a velocity (speed and movement direction) at the position, and indirectly calculates the Doppler shift value, based on the acquired information. In other words, the index related to the deviation of the radio frequency described above is the Doppler shift value herein. Note that, the Doppler shift value may be calculated for each base station, for each cell, for each sector, or for each beam.

In the third example embodiment, an area setting unit 1122 divides the communication area of the base station 10 into a plurality of sub-areas, based on an index (i.e., Doppler shift value) indicating the radio channel characteristic. The area setting unit 1122 may divide the communication area of the base station 10 into a plurality of sub-areas by using, for example, two threshold values Th1 and Th2, and the Doppler shift values of a plurality of points in the communication area of the base station 10. The area setting unit 1122 allocates a point having the Doppler shift value whose absolute value is equal to or greater than the threshold Th1 to a “high Doppler shift value area”. In addition, the area setting unit 1122 allocates a point having the Doppler shift value whose absolute value is less than the threshold Th1 and is equal to or greater than the threshold Th2 to a “middle Doppler shift value area”. In addition, the area setting unit 1122 allocates a point having the Doppler shift value whose absolute value is less than threshold Th2 to a “low Doppler shift value area”.

In the third example embodiment, a determination unit 1123 determines communication operation to be applied to a target terminal, based on information related to a sub-area associated to the target terminal. Herein, the information related to the sub-area associated to the target terminal may be type information of the sub-area in which the target terminal is located. In addition, the communication operation to be applied to the target terminal may be communication operation performed by the base station 10, may be communication operation performed by the target terminal, or may be both of them. In addition, the communication operation to be applied to the target terminal may be communication operation at a time of reception, may be communication operation at a time of transmission, or may be both of them.

For example, in a case where the target terminal is located in the high Doppler shift value area, the determination unit 1123 may determine a frequency correction value as a first value. Then, frequency correction such as automatic frequency control (AFC) using the first value may be performed. In addition, in a case where the target terminal is located in the middle Doppler shift value area, the determination unit 1123 may determine the frequency correction value as a second value. Then, the frequency correction using the second value may be performed. In addition, in a case where the target terminal is located in the low Doppler shift value area, the determination unit 1123 may determine the frequency correction value as a third value. Then, the frequency correction using the third value may be performed. Note that, as a position of the target terminal, for example, position coordinates acquired from a GPS of the target terminal may be used.

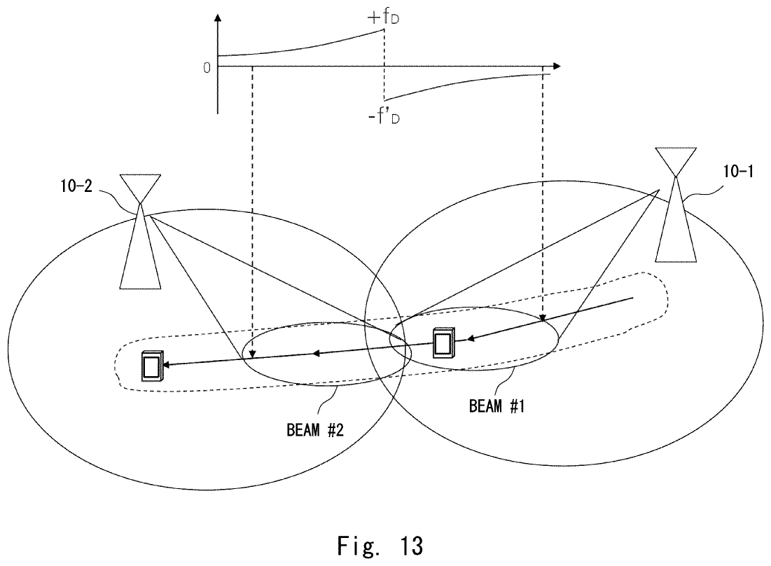

FIG. 13 is a diagram for describing the Doppler shift value according to the present disclosure. In FIG. 13, in a case where the radio terminal is moving to a left direction, when the radio terminal is connected to a beam #1 of a base station 10-1, a negative Doppler shift occurs. On the other hand, when the radio terminal is connected to a beam #2 of a base station 10-2, a positive Doppler shift occurs. In a case where the radio terminal switches a connection destination from the beam #1 of the base station 10-1 to the beam #2 of the base station 10-2, the Doppler shift received by the radio terminal abruptly changes from −f′_D to +f_D. There is a possibility that such an abrupt change in the Doppler shift causes communication performance to deteriorate. In other words, an abrupt change in the Doppler shift value often occurs at a time of switching of a base station, a cell, a sector, a beam, or the like, and in a section in which there is no switching, the Doppler shift value changes relatively gently. Therefore, the determination unit 1123 may determine execution of processing of correcting the deviation of the radio frequency by using, as a trigger, the change in the base station, the cell, the sector, or the beam connected to the target terminal.

### Fourth Example Embodiment

In a fourth example embodiment, an index related to a propagation delay of a radio wave is used as an index indicating a radio channel characteristic. Note that, since a basic configuration of a radio communication system, a base station, and a radio terminal according to the fourth example embodiment is the same as that of the radio communication system 1, the base station 10, and the radio terminal 20, reference is made to FIGS. 1, 4 to 6, and 11.

In the fourth example embodiment, an acquisition unit 1121 acquires an index related to a propagation delay of a radio wave as an “index indicating a radio channel characteristic”.

For example, in the fourth example embodiment, a DB generation unit 1121A acquires channel measurement data (e.g., information related to a position of a radio terminal 20, and a propagation delay value of a radio wave at the position) between a base station 10 and the radio terminal 20.

The DB generation unit 1121A registers the acquired channel measurement data in a database. For example, the DB generation unit 1121A may register the acquired channel measurement data in the database for each base station, for each cell, for each sector, or for each beam.

An index acquisition unit 1121B acquires an index indicating a radio channel characteristic for each position coordinate point in a communication area of the base station 10. For example, in a case where data of the propagation delay of the radio wave between the radio terminal and the base station is held in the database, the index acquisition unit 1121B acquires a propagation delay value of the radio wave for each position coordinate point in the communication area of the base station 10.

In the fourth example embodiment, an area setting unit 1122 divides the communication area of the base station 10 into a plurality of sub-areas, based on an index (i.e., a propagation delay value of a radio wave) indicating the radio channel characteristic. The area setting unit 1122 may divide the communication area of the base station 10 into a plurality of sub-areas by using, for example, two threshold values Th1 and Th2, and the propagation delay values of radio waves at a plurality of points in the communication area of the base station 10. For example, the area setting unit 1122 allocates a point having the propagation delay value of the radio wave being equal to or greater than the threshold Th1 to a “high propagation delay value area”. In addition, the area setting unit 1122 allocates a point having the propagation delay value that is less than the threshold Th1 and is equal to or greater than the threshold Th2 to a “middle propagation delay value area”. In addition, the area setting unit 1122 allocates a point having the propagation delay value being less than the threshold Th2 to a “low propagation delay value area”.

In the fourth example embodiment, a determination unit 1123 determines communication operation to be applied to a target terminal, based on information related to a sub-area associated to the target terminal. Herein, the information related to the sub-area associated to the target terminal may be type information of the sub-area in which the target terminal is located. In addition, the communication operation to be applied to the target terminal may be communication operation performed by the base station 10, may be communication operation performed by the target terminal, or may be both of them. In addition, the communication operation to be applied to the target terminal may be communication operation at a time of reception, may be communication operation at a time of transmission, or may be both of them.

For example, in a case where the target terminal is located in the high propagation delay value area, the determination unit 1123 may determine a transmission timing correction value as a first value. Then, transmission timing correction such as timing advance (TA) technique using the first value may be performed. In addition, in a case where the target terminal is located in the middle propagation delay value area, the determination unit 1123 may determine the transmission timing correction value as a second value. Then, the transmission timing correction using the second value may be performed. In addition, in a case where the target terminal is located in the low propagation delay value area, the determination unit 1123 may determine the transmission timing correction value as a third value. Then, the transmission timing correction using the third value may be performed. Note that, as a position of the target terminal, for example, position coordinates acquired from a GPS of the target terminal may be used.

In a UL of a radio communication system, a timing advance technique is used as a technique for synchronizing reception timing at a time when a base station receives a signal transmitted by a plurality of radio terminals. For example, in a case where a plurality of radio terminals are orthogonal each other by orthogonal frequency division multiplexing (OFDM) in the UL of the radio communication system using OFDM, when a deviation in reception timing at a base station due to a path difference between the radio terminals exceeds a cyclic prefix (CP) length of OFDM, orthogonality between the radio terminals is lost. As a result, there is a possibility that serious inter-symbol interference occurs.

Information related to TA for determining the transmission timing of the radio terminal is notified from the base station to the radio terminal by a random access reply or a media access control control element (MAC CE). The notification is performed at a period relatively longer than a slot length at a time of communication. For this reason, in a case where the propagation delay between the radio terminal and the base station abruptly changes (e.g., in a case or the like where the radio terminal switches a radio apparatus, a base station, a beam, or the like being a connection destination), compensation for the propagation delay by the TA does not operate properly, and there is a possibility that the orthogonality between the radio terminals is lost. In other words, an abrupt change in the propagation delay value often occurs at a time of switching of a base station, a cell, a sector, a beam, or the like, and in a section in which there is no switching, the propagation delay value changes relatively gently. Therefore, the determination unit 1123 may determine execution of processing of correcting the transmission timing by using, as a trigger, the change in the base station, the cell, the sector, or the beam connected to the target terminal.

### Fifth Example Embodiment

In a fifth example embodiment, a channel gain or the like of a radio channel is used as an index indicating a radio channel characteristic. Note that, since a basic configuration of a radio communication system, a base station, and a radio terminal according to the fifth example embodiment is the same as that of the radio communication system 1, the base station 10, and the radio terminal 20, reference is made to FIGS. 1, 4 to 6, and 11.

In the fifth example embodiment, an acquisition unit 1121 acquires an index indicating a radio channel characteristic. The “index indicating the radio channel characteristic” is, for example, reception power of a signal propagated through a radio channel, a channel gain of the radio channel, a path gain, a path loss, a signal to noise power ratio (SNR), or a signal to interference and noise power ratio (SINR).

For example, in the fifth example embodiment, a DB generation unit 1121A acquires channel measurement data (e.g., information related to a position of a radio terminal 20, and an index value indicating the radio channel characteristic at the position) between a base station 10 and the radio terminal 20.

An index acquisition unit 1121B acquires an index indicating a radio channel characteristic for each position coordinate point in a communication area of the base station 10.

In the fifth example embodiment, an area setting unit 1122 divides the communication area of the base station 10 into a plurality of sub-areas, based on an index (e.g., a channel gain value) indicating the radio channel characteristic. The area setting unit 1122 may divide the communication area of the base station 10 into a plurality of sub-areas by using, for example, two threshold values Th1 and Th2, and the channel gain values of a plurality of points in the communication area of the base station 10. For example, the area setting unit 1122 allocates a point having the channel gain value being equal to or greater than the threshold Th1 to a “high channel gain value area”. In addition, the area setting unit 1122 allocates a point having the channel gain value that is less than the threshold Th1 and is equal to or greater than the threshold Th2 to a “middle channel gain value area”. In addition, the area setting unit 1122 allocates a point having the channel gain value being less than the threshold Th2 to a “low channel gain value area”.

In the fifth example embodiment, a determination unit 1123 determines communication operation to be applied to a target terminal, based on information related to a sub-area associated to the target terminal. Herein, the information related to the sub-area associated to the target terminal may be type information of the sub-area in which the target terminal is located. In addition, the communication operation to be applied to the target terminal may be communication operation performed by the base station 10, may be communication operation performed by the target terminal, or may be both of them. In addition, the communication operation to be applied to the target terminal may be communication operation at a time of reception, may be communication operation at a time of transmission, or both of them.

The communication operation to be applied to the target terminal may be one or any combination of transmission power control (TPC) of the target terminal, radio resource allocation to the target terminal in the base station, selection of a modulation and coding scheme (MCS), or selection of a connected base station, a cell, or a beam.

### Sixth Example Embodiment

In a sixth example embodiment, a communication area of a base station is divided into a plurality of sub-areas, based on configuration information of the base station. Note that, since a basic configuration of a radio communication system, a base station, and a radio terminal according to the sixth example embodiment is the same as that of the radio communication system 1, the base station 10, and the radio terminal 20, reference is made to FIGS. 1, 4 to 6, and 11.

In the sixth example embodiment, an acquisition unit 1121 acquires configuration information of the base station. The configuration information of the base station includes, for example, beam information of the base station (e.g., information related to digital or analog beamforming of the base station).

In addition, the acquisition unit 1121 acquires an “index indicating a radio channel characteristic”. For example, a DB generation unit 1121A acquires channel measurement data (e.g., information related to a position of a radio terminal 20, and a value of a channel parameter at the position) between a base station 10 and the radio terminal 20. The DB generation unit 1121A registers the acquired channel measurement data in a database. An index acquisition unit 1121B calculates an index representing the radio channel characteristic for each position coordinate point in a communication area of the base station 10.

In the sixth example embodiment, an area setting unit 1122 divides the communication area of the base station 10 into a plurality of sub-areas, based on the configuration information of the base station. Herein, the configuration information of the base station is beam information of the base station.

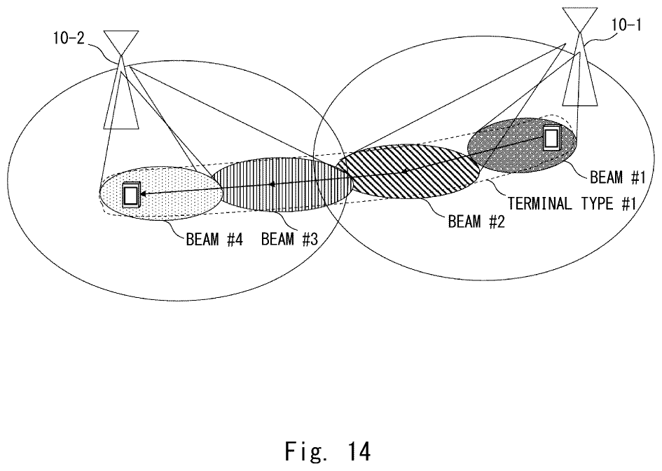

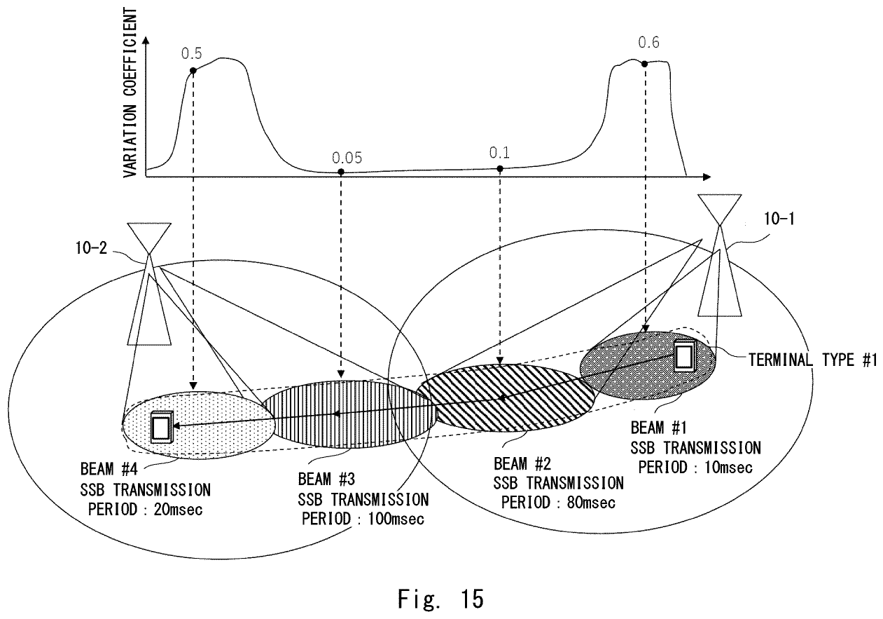

FIGS. 14 and 15 are diagrams for describing another example of a method of dividing a communication area into a plurality of sub-areas according to the present disclosure. In FIG. 14, a communication area of a terminal type #1 is a communication area to be divided. The area setting unit 1122 divides the communication area into a plurality of sub-areas, based on a coverage area of each of a plurality of beams of the base station 10. Specifically, the area setting unit 1122 divides the communication area into a coverage area associated to a beam #1, a coverage area associated to a beam #2, a coverage area associated to a beam #3, and a coverage area associated to a beam #4.

In the sixth example embodiment, a determination unit 1123 may determine communication operation to be applied to a target terminal associated to each sub-area. For example, as illustrated in FIG. 15, the determination unit 1123 acquires a value of a channel parameter at a representative point (e.g., a center point of the sub-area) of each sub-area. Then, the determination unit 1123 determines the communication operation to be applied to the target terminal associated to each sub-area, based on the acquired value of the channel parameter of each sub-area. In the example in FIG. 15, an SSB transmission period of 100 msec is set in the coverage area associated to the beam #3 having a variation coefficient value of 0.05. In addition, the SSB transmission period of 80 msec is set in the coverage area associated to the beam #2 having the variation coefficient value of 0.1. The SSB transmission period of 20 msec is set in the coverage area associated to the beam #4 having the variation coefficient value of 0.5. The SSB transmission period of 10 msec is set in the coverage area associated to the beam #1 having the variation coefficient value of 0.6.

Then, the determination unit 1123 determines the communication operation to be applied to the target terminal, based on information related to the sub-area associated to the target terminal. Herein, the information related to the sub-area associated to the target terminal may be type information of the sub-area in which the target terminal is located. In addition, the communication operation to be applied to the target terminal may be communication operation performed by the base station 10, may be communication operation performed by the target terminal, or may be both of them. In a case where the determination unit 1123 determines the communication operation performed by the target terminal, the base station 10 may notify the target terminal of the communication operation determined by the determination unit 1123. Then, the target terminal may determine operation related to communication of the target terminal, based on the notified information.

Herein, it is assumed that pieces of timing or positions of beam switching for a plurality of different radio terminals are different from each other. In this case, a plurality of sub-areas including a plurality of radio terminals may be allowed to partially overlap between the plurality of sub-areas. At a time when determining the communication operation of the target terminal, in a case where a position of the target terminal belongs to a plurality of sub-areas (i.e., in a case where the target terminal is located in an overlap area of the two sub-areas), the determination unit 1123 can specify the sub-area associated to the target terminal, for example, based on connection destination beam information of the target terminal.

### Seventh Example Embodiment

Some or all of functions of the area setting units 51 and 1122, the determination units 52 and 1123, and the index acquisition unit 1121B described in the first to sixth example embodiments may be performed by inference using a trained machine learning (ML) model. Training of the ML model may be performed by the control apparatus 5 or 11, or may be performed by another networking element, such as near-real Time (RT) RAN intelligent controller (RIC), or non-RT RIC. The area setting units 51 and 1122, the determination units 52 and 1123, and the index acquisition unit 1121B may operate as an ML model inference host, and the another network element such as near-RT RIC or non-RT RIC may operate as an ML model training host.

In some implementations, a database described above is used as input data to the trained ML model. Then, the trained ML model may output, as an inference result, an index representing a radio channel characteristic at each coordinate point of a communication area.

In addition, in some implementations, the database described above and information of a target terminal (e.g., channel state information, position information, terminal type, and the like) are used as input data to the trained ML model. Then, the trained ML model may output, as an inference result, a determination result of operation related to communication with the target terminal.

In addition, in some implementations, an index calculated by the index acquisition unit 1121B and the information of the target terminal are used as input data to the trained ML model. Then, the trained ML model may output, as an inference result, a determination result of operation related to communication with the target terminal.

### Eighth Example Embodiment

An eighth example embodiment corresponds to a case where a control apparatus is included in a radio terminal. Since a basic configuration of a radio communication system according to the eighth example embodiment is the same as that of the radio communication system 1, reference is made to FIG. 1.

### [Configuration Example of Radio Terminal]

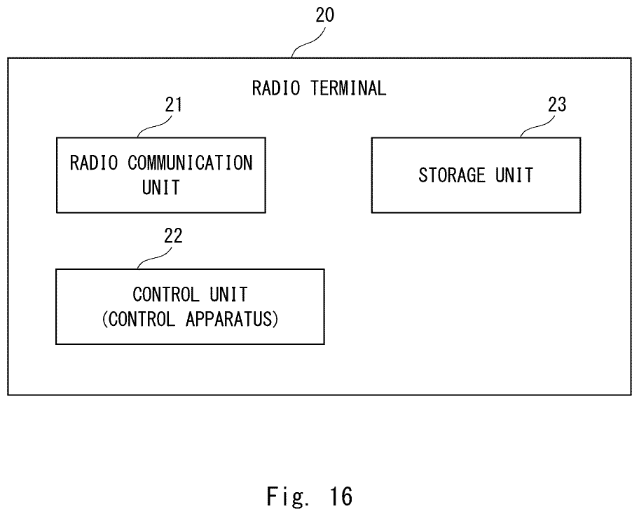

FIG. 16 is a block diagram illustrating one example of a radio terminal according to the present disclosure. In FIG. 16, a radio terminal 20 includes a radio communication unit 21, a control unit (control apparatus) 22, and a storage unit 23.

The radio communication unit 21 is an element that performs radio communication with a radio apparatus 12. For example, the radio communication unit 21 includes an antenna, an RF circuit, and the like.

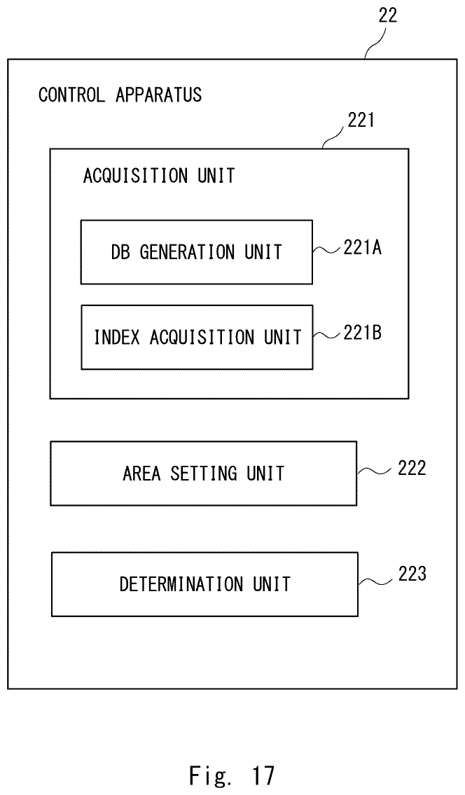

The control apparatus 22 corresponds to the control apparatus 5 described above. FIG. 17 is a block diagram illustrating another example of the control apparatus according to the present disclosure.

In FIG. 17, the control apparatus 22 includes an acquisition unit 221, an area setting unit 222, and a determination unit 223.

The acquisition unit 221 acquires an “index indicating a radio channel characteristic”.

For example, the acquisition unit 221 includes a DB generation unit 221A, and an index acquisition unit 221B.

The DB generation unit 221A acquires channel measurement data (e.g., information related to a position of the radio terminal 20, and a value of a channel parameter at the position) between a base station 10 and the radio terminal 20. However, the channel measurement data to be acquired may be channel data measured by the radio terminal 20 with a base station that has performed communication at present or in a past, or may be channel data measured by simulation. The channel data may be measured by reception of a DL RS transmitted by the base station. The DL RS may be, for example, an SSB, a CSI-RS, a DMRS, and a PT-RS. In addition, the channel data may include influence of an inherent deviation caused by hardware design of a transmission/reception system including a high-frequency circuit of the radio terminal 20. In the present example embodiment, the channel data are measured by the radio terminal 20 itself, and stored in a database. Therefore, channel measurement data not being reported to the base station can also be stored in the database.

The DB generation unit 221A registers the acquired channel measurement data in the database.

The index acquisition unit 221B calculates an index representing a radio channel characteristic for each position coordinate point on a movement path of the radio terminal 20. As a method of acquiring and calculating an index representing the radio channel characteristic, any of the methods described in the second to seventh example embodiments can be used.

The area setting unit 222 divides the movement path of the radio terminal 20 into a plurality of sub-areas, based on an index indicating the radio channel characteristic or a coverage area of each of a plurality of beams of the base station 10. As a method of dividing the movement path into a plurality of sub-areas, any of the methods described in the second to seventh example embodiments can be used.

The determination unit 223 determines communication operation to be applied to the radio terminal 20, based on information related to a sub-area associated to the radio terminal 20. As a method of determining communication operation to be applied to the radio terminal 20, any of the methods described in the second to seventh example embodiments can be used. For example, the communication operation to be applied to the radio terminal 20 may be, for example, change of a channel measurement or a reporting period, or a trigger of reporting of a channel measurement result that does not depend on a period. In addition, the communication operation to be applied to the radio terminal 20 may be operation related to frequency correction such as AFC, propagation delay compensation such as TA, transmission power control, or connected cell/beam selection.

### Ninth Example Embodiment

Some or all of functions of the area setting units 51 and 222, the determination units 52 and 223, and the index acquisition unit 221B described in the first and the eighth example embodiments may be performed by inference using a trained ML model. Training of the ML model may be performed by a control unit 22 of a radio terminal 20. The control unit 22 operates as an ML model inference host.

In some implementations, a database described above is used as input data to the trained ML model. Then, the trained ML model may output, as an inference result, an index representing a radio channel characteristic at each coordinate point on a movement path of the radio terminal 20.

In addition, in some implementations, the database described above and information of the radio terminal 20 (e.g., channel state information, position information, terminal type, and the like) are used as input data to the trained ML model. Then, the trained ML model may output, as an inference result, a determination result of operation related to communication of the radio terminal 20.

In addition, in some implementations, the database described above and information of the radio terminal 20 (e.g., channel state information, position information, terminal type, and the like) are used as input data to the trained ML model. Then, the trained ML model may output, as an inference result, a determination result of operation related to communication of the radio terminal 20.

### Tenth Example Embodiment

A tenth example embodiment relates to an example embodiment in which a control apparatus of a base station and a control apparatus of a radio terminal cooperate with each other. Since a basic configuration of a radio communication system according to the tenth example embodiment is the same as that of the radio communication system 1, reference is made to FIG. 1.

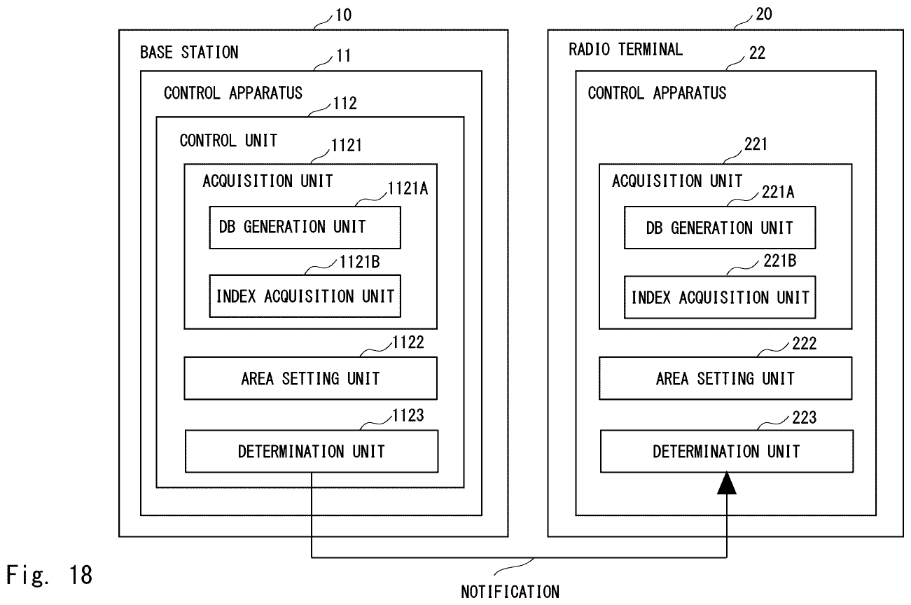

FIG. 18 is a block diagram illustrating another example of a base station and a radio terminal according to the present disclosure. As illustrated in FIG. 18, a basic configuration of the base station and the radio terminal according to the tenth example embodiment is the same as the configuration of the base station 10 and the radio terminal 20 described in the second to ninth example embodiments.

In the tenth example embodiment, a determination unit 1123 of a control apparatus 11 (base station 10) notifies a target terminal of information related to communication operation to be performed by the target terminal, among one or a plurality of pieces of communication operation to be applied to the target terminal determined by the determination unit 1123. Note that, the communication operation to be performed by the base station 10 among one or a plurality of pieces of communication operation to be applied to the target terminal determined by the determination unit 1123 is executed in the base station 10.

In the tenth example embodiment, a determination unit 223 of a control apparatus 22 (radio terminal 20) may determine the communication operation actually to be applied to the radio terminal 20 by using one or both of the communication operation to be performed by the target terminal indicated by information notified from the determination unit 1123, and the communication operation to be applied to the radio terminal 20 determined by the determination unit 223.

For example, operation that can be determined by the determination unit 223 of the radio terminal 20 among pieces of operation related to communication of the radio terminal 20 may be determined based on a determination result in the determination unit 223. Then, operation that cannot be determined by the determination unit 223 of the radio terminal 20 among pieces of operation related to the communication of the radio terminal 20 may instead be determined based on a determination result determined by the determination unit 1123 of the base station 10 and notified.

In a case where each piece of processing is performed only by the base station, a database including channel data of a plurality of radio terminals is available. On the other hand, among the channel data measured by the radio terminal, data not being reported to the base station are unavailable to the base station. Therefore, it is difficult for the base station to determine operation related to communication specialized for each target terminal. On the other hand, in a case where each piece of processing is performed in the radio terminal, the radio terminal can also use data not being reported to the base station, but it is difficult to use data acquired from another radio terminal.

According to the present example embodiment, generation of a database, calculation of an index, setting of an area, and determination of operation related to communication are performed by both of the base station and the radio terminal. As a result, it is possible to enjoy advantages of both the case where each piece of processing is performed by the base station and the case where each piece of processing is performed by the radio terminal.

### Eleventh Example Embodiment

An eleventh example embodiment relates to another example embodiment in which a control apparatus of a base station and a control apparatus of a radio terminal cooperate with each other. Since a basic configuration of a radio communication system according to the eleventh example embodiment is the same as that of the radio communication system 1, reference is made to FIG. 1.

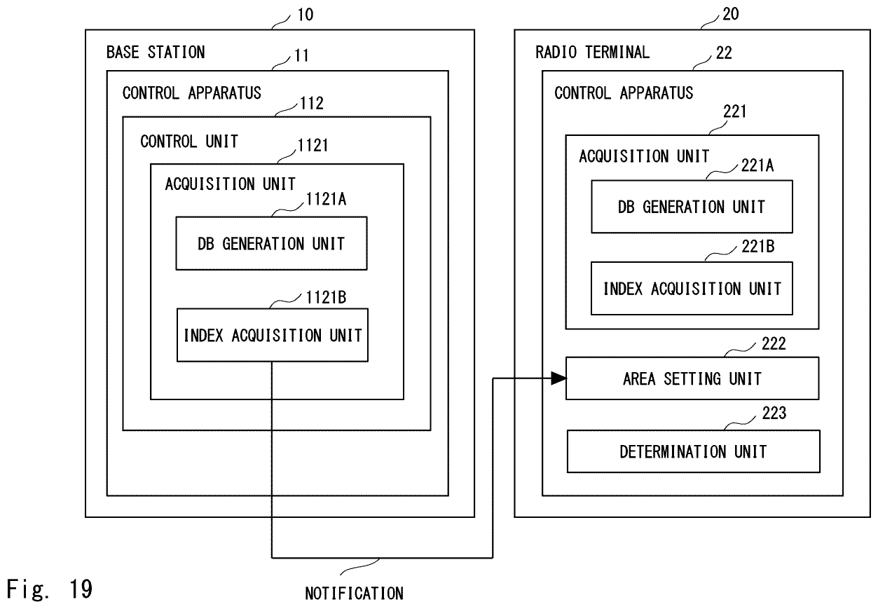

FIG. 19 is a block diagram illustrating another example of a base station and a radio terminal according to the present disclosure. As illustrated in FIG. 19, a basic configuration of the base station and the radio terminal according to the eleventh example embodiment is the same as the configuration of the base station 10 and the radio terminal 20 described in the second to ninth example embodiments.

In the eleventh example embodiment, an index acquisition unit 1121B of a control apparatus 11 (base station 10) notifies a radio terminal 20 of information related to an index that can be used by the radio terminal 20 to set a sub-area, among one or a plurality of indexes representing a radio channel characteristic calculated by the index acquisition unit 1121B.

In the tenth example embodiment, an area setting unit 222 of a control apparatus 22 (radio terminal 20) divides a movement path of the radio terminal 20 into a plurality of sub-areas by using one or both of an index indicated by the information notified from the index acquisition unit 1121B, and an index calculated by an index acquisition unit 221B.

Then, a determination unit 223 determines communication operation to be applied to the radio terminal 20, based on information related to a sub-area associated to the radio terminal 20.

### Twelfth Example Embodiment

A twelfth example embodiment relates to another example embodiment in which a control apparatus of a base station and a control apparatus of a radio terminal cooperate with each other. Since a basic configuration of a radio communication system according to the twelfth example embodiment is the same as that of the radio communication system 1, reference is made to FIG. 1.

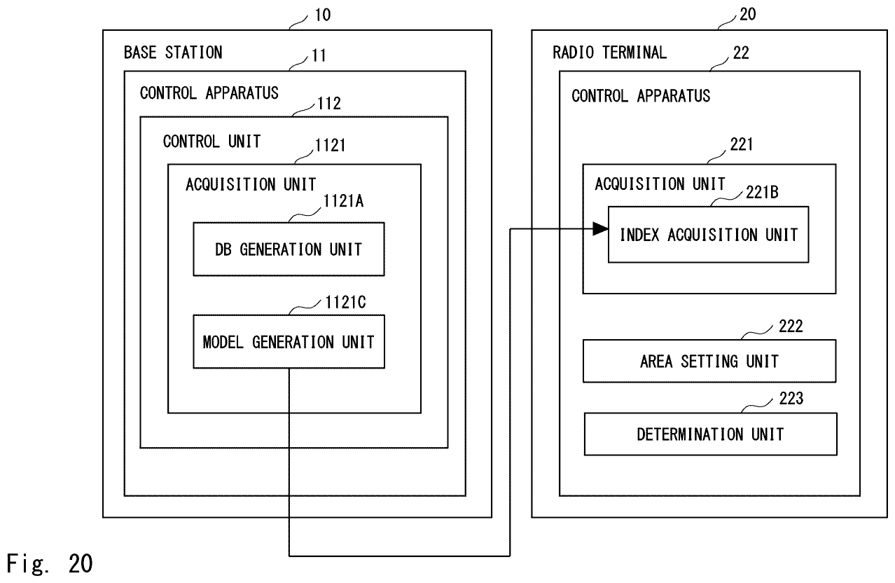

FIG. 20 is a block diagram illustrating another example of a base station and a radio terminal according to the present disclosure. In FIG. 20, a control apparatus 11 of a base station 10 includes a control unit 112. The control unit 112 includes an acquisition unit 1121. The acquisition unit 1121 includes a DB generation unit 1121A, and a model generation unit 1121C.

The model generation unit 1121C generates one or a plurality of learned index calculation models by training one or a plurality of index calculation models by using a database generated by the DB generation unit 1121A. The model generation unit 1121C notifies a radio terminal 20 of information related to a model for performing inference in the radio terminal 20, among the generated one or a plurality of learned index calculation models. In some implementations, the notified information may be one or a plurality of parameters included in the index calculation model. In addition, in some implementations, the notified information may be alternative information that allows the radio terminal 20 to reproduce or approximately reproduce the index calculation model. For example, in a case where the radio terminal 20 holds a plurality of candidates of an inference model, the alternative information may be an index or the like for selecting a model to be used from the candidates of the inference model.

In the twelfth example embodiment, an index acquisition unit 221B of a control apparatus 22 (radio terminal 20) generates an index calculation model by using the information notified from the model generation unit 1121C. Then, the index acquisition unit 221B outputs an index representing a radio channel characteristic by using the generated index calculation model.

In the twelfth example embodiment, an area setting unit 222 divides a movement path of the radio terminal 20 into a plurality of sub-areas, based on an index indicating the radio channel characteristic.

In the twelfth example embodiment, a determination unit 223 determines communication operation to be applied to the radio terminal 20, based on information related to a sub-area associated to the radio terminal 20.

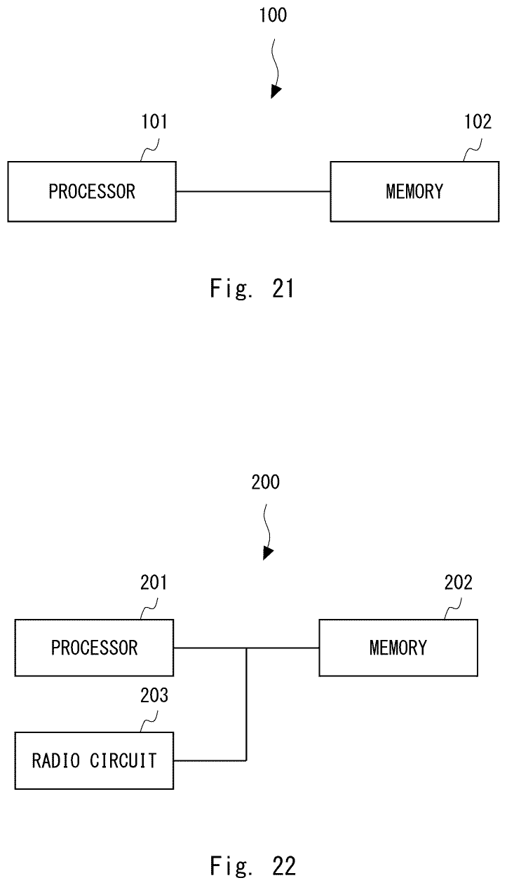

### Another Example Embodiment

<1> FIG. 21 is a diagram illustrating a configuration example of a control apparatus. In FIG. 21, a control apparatus 100 includes a processor 101, and a memory 102. The processor 101 may include, for example, one or more of a central processing unit (CPU), a micro processing unit (MPU), a field programmable gate array (FPGA), and an application specific integrated circuit (ASIC). The processor 101 may include a plurality of processors. The memory 102 is configured by a combination of a volatile memory and a non-volatile memory. The volatile memory may include, for example, a random access memory (RAM). The non-volatile memory may include, for example, one or more of a read only memory (ROM), a hard disk drive (HDD), and a solid state drive (SSD). The memory 102 may include a storage arranged apart from the processor 101. In this case, the processor 101 may access the memory 102 via a not-illustrated input (I)/output (O) interface.

The control apparatuses 5 and 11 according to the first to seventh example embodiments and the tenth to twelfth example embodiments can each have a configuration illustrated in FIG. 21. The area setting unit 51, the determination unit 52, and the control unit 112 of the control apparatuses 5 and 11 according to the first to seventh example embodiments and the tenth to twelfth example embodiments may be achieved by the processor 101 reading and executing a program stored in the memory 102. In other words, the control apparatuses 5 and 11 according to the first to seventh example embodiments and the tenth to twelfth example embodiments can be achieved by software. The storage unit 113 is achieved by the memory 102. The program can be stored and provided to the control apparatuses 5 and 11 using any type of non-transitory computer readable media. Examples of non-transitory computer readable media include magnetic storage media (such as floppy disks, magnetic tapes, hard disk drives, etc.), and optical magnetic storage media (e.g., magneto-optical disks). Further, examples of non-transitory computer readable media include CD-ROM (compact disc read only memory), CD-R (compact disc recordable), and CD-R/W (compact disc rewritable). Furthermore, examples of non-transitory computer readable media include semiconductor memories. The semiconductor memory includes, for example, a mask ROM, a PROM (programmable ROM), an EPROM (erasable PROM), a flash ROM, and a RAM (random access memory). The program may also be provided to the control apparatuses 5 and 11 using any type of transitory computer readable media. Examples of transitory computer readable media include electrical signals, optical signals, and electromagnetic waves. The transitory computer readable media can provide the program to the control apparatuses 5 and 11 via a wired communication line (e.g., electric wires, and optical fibers) or a radio communication line.

Alternatively, each of the area setting unit 51, the determination unit 52, and the control unit 112 of the control apparatuses 5 and 11 according to the first to seventh example embodiments and the tenth to twelfth example embodiments may be achieved by dedicated hardware. In addition, some or all of the constituent elements of each apparatus may be achieved by general-purpose or dedicated circuitry, a processor, or the like, or a combination thereof.

<2> FIG. 22 is a diagram illustrating a configuration example of a radio terminal. In FIG. 22, a radio terminal 200 includes a processor 201, a memory 202, and a radio circuit 203. The processor 201 may include, for example, one or more of a central processing unit (CPU), a micro processing unit (MPU), a field programmable gate array (FPGA), and an application specific integrated circuit (ASIC). The processor 201 may include a plurality of processors. The memory 202 is configured by a combination of a volatile memory and a non-volatile memory. The volatile memory may include, for example, a random access memory (RAM). The non-volatile memory may include, for example, one or more of a read only memory (ROM), a hard disk drive (HDD), and a solid state drive (SSD). The memory 202 may include a storage arranged apart from the processor 201. In this case, the processor 201 may access the memory 202 via a not-illustrated input (I)/output (O) interface. The radio circuit 203 includes an antenna.

The radio terminals 20 according to the first example embodiment, and the eighth to twelfth example embodiments can each have a configuration illustrated in FIG. 22. The area setting unit 51, the determination unit 52, and the control unit 22 of the radio terminal 20 according to the first example embodiment, and the eighth to twelfth example embodiments may be achieved by the processor 201 reading and executing a program stored in the memory 202. In other words, the radio terminal 20 according to the first example embodiment, and the eighth to twelfth example embodiments can be achieved by software. The storage unit 23 is achieved by the memory 202. The radio communication unit 21 is achieved by the radio circuit 203. The program can be stored and provided to the radio terminal 20 using any type of non-transitory computer readable media. Examples of non-transitory computer readable media include magnetic storage media (such as floppy disks, magnetic tapes, hard disk drives, etc.), and optical magnetic storage media (e.g., magneto-optical disks). Further, examples of non-transitory computer readable media include CD-ROM (compact disc read only memory), CD-R (compact disc recordable), and CD-R/W (compact disc rewritable). Furthermore, examples of non-transitory computer readable media include semiconductor memories. The semiconductor memory includes, for example, a mask ROM, a PROM (programmable ROM), an EPROM (erasable PROM), a flash ROM, and a RAM (random access memory). The program may also be provided to the radio terminal 20 using any type of transitory computer readable media. Examples of transitory computer readable media include electrical signals, optical signals, and electromagnetic waves. The transitory computer readable media can provide the program to the radio terminal 20 via a wired communication line (e.g., electric wires, and optical fibers) or a radio communication line.

Alternatively, each of the area setting unit 51, the determination unit 52, and the control unit 22 of the radio terminal 20 according to the first example embodiment, and the eighth to twelfth example embodiments may be achieved by dedicated hardware. In addition, some or all of the constituent elements of each apparatus may be achieved by general-purpose or dedicated circuitry, a processor, or the like, or a combination thereof.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Some or all of the above-described example embodiments may be described as the following supplementary notes, but are not limited thereto.

### (Supplementary Note 1)

A control apparatus that controls at least one base station, the control apparatus including:
an area setting unit configured to divide at least one communication area of the at least one base station into a plurality of sub-areas, based on at least one of an index indicating a radio channel characteristic and a coverage area of each of a plurality of beams of the at least one base station; and
a determination unit configured to determine communication operation to be applied to a target terminal, based on information related to a sub-area associated to the target terminal.

### (Supplementary Note 2)

The control apparatus according to supplementary note 1, wherein,
in a case where the area setting unit divides at least one communication area of the at least one base station into the plurality of sub-areas, based on an index indicating the radio channel characteristic, information related to a sub-area associated to the target terminal is type information of a sub-area in which the target terminal is located, and
the determination unit determines communication operation associated with the type information of the sub-area as communication operation to be applied to the target terminal.

### (Supplementary Note 3)

The control apparatus according to supplementary note 1, wherein,
in a case where the area setting unit divides at least one communication area of the at least one base station into the plurality of sub-areas, based on a coverage area of each of a plurality of beams of the at least one base station, information related to a sub-area associated to the target terminal is an index indicating the radio channel characteristic in a sub-area in which the target terminal is located, and
the determination unit determines communication operation to be applied to the target terminal, based on the index indicating the radio channel characteristic in a sub-area in which the target terminal is located.

### (Supplementary Note 4)

The control apparatus according to supplementary note 2 or 3, wherein
the index indicating the radio channel characteristic is reception power of a signal propagated through a radio channel, a channel gain of the radio channel, a path gain, a path loss, a signal to noise power ratio, or a signal to interference and noise power ratio, and
communication operation to be applied to the target terminal is any of transmission power control, radio resource allocation, and connected cell/beam selection.

### (Supplementary Note 5)

The control apparatus according to supplementary note 1, wherein,
in a case where the area setting unit divides at least one communication area of the at least one base station into the plurality of sub-areas, based on a coverage area of each of a plurality of beams of the at least one base station, information related to a sub-area associated to the target terminal is information indicating a beam to be connected to the target terminal, and
the determination unit determines communication operation associated with a beam connected to the target terminal as communication operation to be applied to the target terminal.

### (Supplementary Note 6)

The control apparatus according to supplementary note 1, wherein
the index indicating the radio channel characteristic is an index related to a deviation of radio frequency at a time of radio communication between a radio terminal and the at least one base station,
the area setting unit divides at least one communication area of the at least one base station into a plurality of sub-areas, in response to a level of the index related to the deviation of the radio frequency, and
the determination unit determines execution of processing of correcting the deviation of the radio frequency, in response to a level of the index related to the deviation of the radio frequency associated to the sub-area associated to the target terminal.

### (Supplementary Note 7)

The control apparatus according to supplementary note 1, wherein
the index indicating the radio channel characteristic is an index related to a deviation of a radio frequency at a time of radio communication between a radio terminal and the at least one base station, and
the determination unit determines execution of processing of correcting the deviation of the radio frequency by using, as a trigger, a change in a base station, a cell, a sector, or a beam connected to the target terminal.

### (Supplementary Note 8)

The control apparatus according to supplementary note 1, wherein
the index indicating the radio channel characteristic is an index related to a speed of time variation of a channel parameter at a time of radio communication between a radio terminal and the at least one base station,
the area setting unit divides at least one communication area of the at least one base station into a plurality of sub-areas, in response to a level of the index related to the speed of time variation of the channel parameter, and
the determination unit determines a measurement period of the channel parameter, in response to a level of the index related to the speed of time variation of the channel parameter associated to the sub-area associated to the target terminal.

### (Supplementary Note 9)

The control apparatus according to supplementary note 1, wherein
the index indicating the radio channel characteristic is an index related to a propagation delay of a radio wave at a time of radio communication between a radio terminal and the at least one base station,
the area setting unit divides at least one communication area of the at least one base station into a plurality of sub-areas, in response to a level of the index related to the propagation delay of the radio wave, and
the determination unit determines execution of processing of compensating for a propagation delay, in response to a level of the index related to the propagation delay of the radio wave associated to the sub-area associated to the target terminal.

### (Supplementary Note 10)

The control apparatus according to supplementary note 1, wherein
the index indicating the radio channel characteristic is an index related to a propagation delay of a radio wave at a time of radio communication between a radio terminal and the at least one base station, and
the determination unit determines execution of processing of compensating for the propagation delay by using, as a trigger, a change in a base station, a cell, a sector, or a beam connected to the target terminal.

### (Supplementary Note 11)

The control apparatus according to supplementary note 1, wherein
the area setting unit sets the plurality of sub-areas for each type of a radio terminal, and
the determination unit determines communication operation to be applied to the target terminal, based on information related to a sub-area that is associated to the type of the target terminal and in which the target terminal is located.

### (Supplementary Note 12)

The control apparatus according to supplementary note 11, wherein the type of the radio terminal is determined based on a position of a radio terminal or movement information.

### (Supplementary Note 13)

The control apparatus according to supplementary note 11, wherein the type of the radio terminal is determined based on an apparatus configuration of a radio terminal.

### (Supplementary Note 14)

The control apparatus according to supplementary note 11, wherein the type of the radio terminal is determined based on a capability of a radio terminal.

### (Supplementary Note 15)

A first radio terminal that communicates with at least one base station, the first radio terminal including:
an area setting unit configured to divide a movement path of the first radio terminal into a plurality of sub-areas, based on at least one of an index indicating a radio channel characteristic and a coverage area of each of a plurality of beams of the at least one base station; and
a determination unit configured to determine communication operation to be applied to the first radio terminal, based on information related to a sub-area associated to the first radio terminal.

### (Supplementary Note 16)

The first radio terminal according to supplementary note 15, wherein,
in a case where the area setting unit divides the movement path of the first radio terminal into the plurality of sub-areas, based on an index indicating the radio channel characteristic, information related to a sub-area associated to the first radio terminal is type information of a sub-area in which the first radio terminal is located, and
the determination unit determines communication operation associated with the type information of the sub-area as communication operation to be applied to the first radio terminal.

### (Supplementary Note 17)

The first radio terminal according to supplementary note 15, wherein,
in a case where the area setting unit divides the movement path of the first radio terminal into the plurality of sub-areas, based on a coverage area of each of a plurality of beams of the at least one base station, information related to a sub-area associated to the first radio terminal is an index indicating the radio channel characteristic in a sub-area in which the first radio terminal is located, and
the determination unit determines communication operation to be applied to the first radio terminal, based on the index indicating the radio channel characteristic in a sub-area in which the first radio terminal is located.

### (Supplementary Note 18)

The first radio terminal according to supplementary note 16 or 17, wherein
the index indicating the radio channel characteristic is reception power of a signal propagated through a radio channel, a channel gain of the radio channel, a path gain, a path loss, a signal to noise power ratio, or a signal to interference and noise power ratio, and
communication operation to be applied to the first radio terminal is any of transmission power control, radio resource allocation, or connected cell/beam selection.

### (Supplementary Note 19)

The first radio terminal according to supplementary note 15, wherein,
in a case where the area setting unit divides the movement path of the first radio terminal into the plurality of sub-areas, based on a coverage area of each of a plurality of beams of the at least one base station, information related to a sub-area associated to the first radio terminal is information indicating a beam to be connected to the first radio terminal, and
the determination unit determines communication operation associated with a beam connected to the first radio terminal as communication operation to be applied to the first radio terminal.

### (Supplementary Note 20)

The first radio terminal according to supplementary note 15, wherein
the index indicating the radio channel characteristic is an index related to a deviation of a radio frequency at a time of radio communication between a radio terminal and the at least one base station,
the area setting unit divides at least one communication area of the at least one base station into a plurality of sub-areas, in response to a level of the index related to the deviation of the radio frequency, and
the determination unit determines execution of processing of correcting the deviation of the radio frequency, in response to a level of the index related to the deviation of the radio frequency associated to the sub-area associated to the first radio terminal.

### (Supplementary Note 21)

The first radio terminal according to supplementary note 15, wherein
the index indicating the radio channel characteristic is an index related to a deviation of a radio frequency at a time of radio communication between a radio terminal and the at least one base station, and
the determination unit determines execution of processing of correcting the deviation of the radio frequency by using, as a trigger, a change in a base station, a cell, a sector, or a beam connected to the first radio terminal.

### (Supplementary Note 22)

The first radio terminal according to supplementary note 15, wherein
the index indicating the radio channel characteristic is an index related to a speed of time variation of a channel parameter at a time of radio communication between a radio terminal and the at least one base station,
the area setting unit divides at least one communication area of the at least one base station into a plurality of sub-areas, in response to a level of the index related to the speed of time variation of the channel parameter, and
the determination unit determines a measurement period of the channel parameter, in response to a level of the index related to the speed of time variation of the channel parameter associated to the sub-area associated to the first radio terminal.

### (Supplementary Note 23)

The first radio terminal according to supplementary note 15, wherein
the index indicating the radio channel characteristic is an index related to a propagation delay of a radio wave at a time of radio communication between a radio terminal and the at least one base station,
the area setting unit divides at least one communication area of the at least one base station into a plurality of sub-areas, in response to a level of the index related to the propagation delay of the radio wave, and
the determination unit determines execution of processing of compensating for a propagation delay, in response to a level of the index related to the propagation delay of the radio wave associated to the sub-area associated to the first radio terminal.

### (Supplementary Note 24)

The first radio terminal according to supplementary note 15, wherein
the index indicating the radio channel characteristic is an index related to a propagation delay of a radio wave at a time of radio communication between a radio terminal and the at least one base station, and
the determination unit determines execution of processing of compensating for the propagation delay by using, as a trigger, a change in a base station, a cell, a sector, or a beam connected to the first radio terminal.

### (Supplementary Note 25)

A method executed by a control apparatus that controls at least one base station, the method including:
dividing at least one communication area of the at least one base station into a plurality of sub-areas, based on at least one of an index indicating a radio channel characteristic and a coverage area of each of a plurality of beams of the at least one base station; and
determining communication operation to be applied to a target terminal, based on information related to a sub-area associated to the target terminal.

### (Supplementary Note 26)

A program causing a control apparatus that controls at least one base station to execute processing including:
dividing at least one communication area of the at least one base station into a plurality of sub-areas, based on at least one of an index indicating a radio channel characteristic and a coverage area of each of a plurality of beams of the at least one base station; and
determining communication operation to be applied to a target terminal, based on information related to a sub-area associated to the target terminal.

### (Supplementary Note 27)

A method executed by a first radio terminal that communicates with at least one base station, the method including:
dividing a movement path of the first radio terminal into a plurality of sub-areas, based on at least one of an index indicating a radio channel characteristic and a coverage area of each of a plurality of beams of the at least one base station; and
determining communication operation to be applied to the first radio terminal, based on information related to a sub-area associated to the first radio terminal.

### (Supplementary Note 28)

A program causing a first radio terminal that communicates with at least one base station to execute processing including:
dividing a movement path of the first radio terminal into a plurality of sub-areas, based on at least one of an index indicating a radio channel characteristic and a coverage area of each of a plurality of beams of the at least one base station; and
determining communication operation to be applied to the first radio terminal, based on information related to a sub-area associated to the first radio terminal.

What is claimed is:

1. A method executed by a control apparatus that controls at least one base station, the method comprising:
dividing at least one communication area of the at least one base station into a plurality of sub-areas, based on at least one of an index indicating a radio channel characteristic and a coverage area of each of a plurality of beams of the at least one base station; and
determining communication operation to be applied to a target terminal, based on information related to a sub-area associated to the target terminal.

2. The method according to claim 1, wherein,
in a case where at least one communication area of the at least one base station is divided into the plurality of sub-areas, based on an index indicating the radio channel characteristic, information related to a sub-area associated to the target terminal is type information of a sub-area in which the target terminal is located, and
the determining includes determining communication operation associated with the type information of the sub-area as communication operation to be applied to the target terminal.

3. The method according to claim 1, wherein,
in a case where at least one communication area of the at least one base station is divided into the plurality of sub-areas, based on a coverage area of each of a plurality of beams of the at least one base station, information related to a sub-area associated to the target terminal is an index indicating the radio channel characteristic in a sub-area in which the target terminal is located, and
the determining includes determining communication operation to be applied to the target terminal, based on the index indicating the radio channel characteristic in a sub-area in which the target terminal is located.

4. The method according to claim 1, wherein,
in a case where at least one communication area of the at least one base station is divided into the plurality of sub-areas, based on a coverage area of each of a plurality of beams of the at least one base station, information related to a sub-area associated to the target terminal is information indicating a beam to be connected to the target terminal, and
the determining includes determining communication operation associated with a beam connected to the target terminal as communication operation to be applied to the target terminal.

5. The method according to claim 1, wherein
the index indicating the radio channel characteristic is an index related to a deviation of a radio frequency at a time of radio communication between a radio terminal and the at least one base station,
the dividing includes dividing at least one communication area of the at least one base station into a plurality of sub-areas, in response to a level of the index related to the deviation of the radio frequency, and
the determining includes determining execution of processing of correcting the deviation of the radio frequency, in response to a level of the index related to the deviation of the radio frequency associated to the sub-area associated to the target terminal.

6. The method according to claim 1, wherein
the index indicating the radio channel characteristic is an index related to a speed of time variation of a channel parameter at a time of radio communication between a radio terminal and the at least one base station,
the dividing includes dividing at least one communication area of the at least one base station into a plurality of sub-areas, in response to a level of the index related to the speed of time variation of the channel parameter, and
the determining includes determining a measurement period of the channel parameter, in response to a level of the index related to the speed of time variation of the channel parameter associated to the sub-area associated to the target terminal.

7. The method according to claim 1, wherein
the index indicating the radio channel characteristic is an index related to a propagation delay of a radio wave at a time of radio communication between a radio terminal and the at least one base station,
the dividing includes dividing at least one communication area of the at least one base station into a plurality of sub-areas, in response to a level of the index related to the propagation delay of the radio wave, and
the determining includes determining execution of processing of compensating for a propagation delay, in response to a level of the index related to the propagation delay of the radio wave associated to the sub-area associated to the target terminal.

8. A method executed by a first radio terminal that communicates with at least one base station, the method comprising:
dividing a movement path of the first radio terminal into a plurality of sub-areas, based on at least one of an index indicating a radio channel characteristic and a coverage area of each of a plurality of beams of the at least one base station; and
determining communication operation to be applied to the first radio terminal, based on information related to a sub-area associated to the first radio terminal.

9. The method according to claim 8, wherein,
in a case where the movement path of the first radio terminal is divided into the plurality of sub-areas, based on an index indicating the radio channel characteristic, information related to a sub-area associated to the first radio terminal is type information of a sub-area in which the first radio terminal is located, and
the determining includes determining communication operation associated with the type information of the sub-area as communication operation to be applied to the first radio terminal.

10. The method according to claim 8, wherein,
in a case where the movement path of the first radio terminal is divided into the plurality of sub-areas, based on a coverage area of each of a plurality of beams of the at least one base station, information related to a sub-area associated to the first radio terminal is an index indicating the radio channel characteristic in a sub-area in which the first radio terminal is located, and
the determining includes determining communication operation to be applied to the first radio terminal, based on the index indicating the radio channel characteristic in a sub-area in which the first radio terminal is located.

11. The method according to claim 8, wherein,
in a case where the movement path of the first radio terminal is divided into the plurality of sub-areas, based on a coverage area of each of a plurality of beams of the at least one base station, information related to a sub-area associated to the first radio terminal is information indicating a beam to be connected to the first radio terminal, and
the determining includes determining communication operation associated with a beam connected to the first radio terminal as communication operation to be applied to the first radio terminal.

12. The method according to claim 8, wherein
the index indicating the radio channel characteristic is an index related to a deviation of a radio frequency at a time of radio communication between a radio terminal and the at least one base station,
the dividing includes dividing at least one communication area of the at least one base station into a plurality of sub-areas, in response to a level of the index related to the deviation of the radio frequency, and
the determining includes determining execution of processing of correcting the deviation of the radio frequency, in response to a level of the index related to the deviation of the radio frequency associated to the sub-area associated to the first radio terminal.

13. The method according to claim 8, wherein
the index indicating the radio channel characteristic is an index related to a speed of time variation of a channel parameter at a time of radio communication between a radio terminal and the at least one base station,
the dividing includes dividing at least one communication area of the at least one base station into a plurality of sub-areas, in response to a level of the index related to the speed of time variation of the channel parameter, and
the determining includes determining a measurement period of the channel parameter, in response to a level of the index related to the speed of time variation of the channel parameter associated to the sub-area associated to the first radio terminal.

14. The method according to claim 8, wherein
the index indicating the radio channel characteristic is an index related to a propagation delay of a radio wave at a time of radio communication between a radio terminal and the at least one base station,
the dividing includes dividing at least one communication area of the at least one base station into a plurality of sub-areas, in response to a level of the index related to the propagation delay of the radio wave, and
the determining includes determining execution of processing of compensating for a propagation delay, in response to a level of the index related to the propagation delay of the radio wave associated to the sub-area associated to the first radio terminal.

15. A control apparatus that controls at least one base station, comprising:
at least one memory; and
at least one processor coupled to the at least one memory, wherein
the at least one processor is configured in such a way as to
divide at least one communication area of the at least one base station into a plurality of sub-areas, based on at least one of an index indicating a radio channel characteristic and a coverage area of each of a plurality of beams of the at least one base station, and
determine communication operation to be applied to a target terminal, based on information related to a sub-area associated to the target terminal.
